(19) United States
(12) Patent Application Publication
(10) Pub. No.: US 2002/0099599 A1
(43) Pub. Date: Jul. 25, 2002

(54) Transportation coordination system and associated method

(76) Inventor: Karnik Minassian, Flushing, NY (US)

Correspondence Address: R. Neil Sudol, Coleman Sudol, LLP, 14th Floor, 708 Third Avenue, New York, NY, 10017, US

(21) Appl. No.: 09/766,468

(22) Filed: Jan. 19, 2001

(51) Int. Cl. G06F 17/60

(52) U.S. Cl. 705/13

(57) ABSTRACT

A transportation coordinating system interfaces with a transportation system having a plurality of transportation service providers serving a plurality of client organizations in a given area. The transportation coordinating system includes a first communication link for enabling the transmission of transportation orders or requests from individuals of the various client organizations, at least one central computer operatively connected to the first communication link for receiving transportation orders or requests from the individuals, and a second communication link for operatively connecting the central computer to management computers of the transportation service providers. The central computer is programmed to automatically access preselected ones of the management computers in response to orders or requests received from the individuals over the first communication link. The central computer is further programmed to have searches undertaken of databases or memories of the preselected management computers for available transportation vehicles of respective preselected transportation service providers.

### BACKGROUND OF THE INVENTION

The invention relates to the field of transportation. More particularly, this invention relates to a system and an associated method for coordinating or managing the provision or securing of transportation services.

One of the mainstays of ground transportation in the United States is limousine services. These services are provided by a plethora of disparate limousine or car service companies. A major metropolitan region can have thousands of different limousine service companies.

Corporations make extensive use of limousine services. To obtain a limousine ride, a corporate employee contacts a respective limousine company by telephone to request a vehicle for transporting the employee or another person from a location specified by the employee during the placement of the telephone request. The destination, as well as other preferred transportation parameters such as type of car and route, may also be specified by the car requester at the time the request is placed. The transportation services are billed by the limousine companies to the corporate user organizations periodically, for instance, weekly or monthly.

Upon receiving a request for a limousine ride, the limousine service company has a dispatcher consult a company computer which is used to track the locations and availabilities of the various cars in the fleet of the limousine company. Generally, car drivers are in continual communication with the home office via respective radio links. A simple switch provided in many limousines has one position for signaling that the respective limousine is available for a pick up and another position for indicating that the limousine and driver are in transit with a passenger or otherwise engaged. The signal generated in response to the switch position is transmitted by radio frequency and may also apprise the central office as to the current location of the respective limousine. The locations of the various limousines of the company's fleet are grouped by preestablished regions. The location of a car in any region indicates that the car is within a certain predetermined time period of any location within that region. This information facilitates the management and coordination of the limousine company's services.

After consulting the company computer to determine car availability with reference to a particular request for transportation services, the dispatcher contacts an available car in the region of the requested pickup location to obtain a confirmation from the driver as to whether that driver is indeed ready, willing and able to pick up a passenger. The driver responds to the confirmation request in part by moving the availability switch to the engaged position.

Each limousine company must have internal rules or policies which guide the dispatcher in selecting cars to fulfill incoming requests. For example, the limousine service company must establish a time for fulfilling service requests. If a car is unable to arrive at the specified pickup location within a certain time, the request for a car must be refused. Otherwise, the car company's clients will be dissatisfied with unduly long waits before limousines arrive.

Another rule followed by a limousine company dispatcher is applicable where several cars are available for the same pickup. Generally, the car which transmits an available signal to the company's dispatch office will be selected first. However, other a different rule may be instituted.

A further rule pertains to the responsiveness of the drivers to confirmation requests. A time interval must be established for giving a driver an opportunity to confirm availability for a pickup. If no response is received from a contacted driver within that time interval, the dispatcher contacts another car.

Other rules are used in conflict situation, for instance, where the company receives more than one transportation order at essentially the same time or in close succession. There may be a reason to fill a later order first, for example, if the later order comes from a bigger account.

The vast majority of major corporations have service contracts with multiple limousine companies. Limousine rides are generally tracked in part by having passengers give drivers vouchers or coupons which confirm that the passengers have the right to a ride under the contract of a client organization.

### SUMMARY OF THE INVENTION

The present invention is directed to a system and an associate methodology for facilitating the provision of transportation services to individuals. The present invention is more particularly directed to a system and methodology which facilitate the provision of transportation services by multiple transportation service providers such as limousine companies to personnel and guests of corporate clients. The system and method are believed to expedite the fulfillment of transportation orders and to be easily adaptable to the communications and transportation preferences of individual users, thus optimizing the service provided by limousine companies.

One embodiment of the present invention is directed to a transportation coordinating system interfacing with a transportation system having a plurality of transportation service providers serving a plurality of client organizations in a given area. The transportation coordinating system comprises a first communication link for enabling the transmission of transportation orders or requests from individuals of the various client organizations, at least one central computer operatively connected to the first communication link for receiving transportation orders or requests from the individuals, and a second communication link for operatively connecting the central computer to management computers of the transportation service providers. The central computer is programmed to automatically access preselected ones of the management computers in response to orders or requests received from the individuals over the first communication link. The central computer is further programmed to have searches undertaken of databases or memories of the preselected management computers for available transportation vehicles of respective preselected transportation service providers. The central computer is additionally programmed to obtain confirmations of available transportation vehicles able to pick up the individuals from respective pick up locations within predetermined time intervals after placement of the orders or requests by the individuals. The central computer is also programmed to communicate the confirmations to the individuals over the first communication link.

Typically, the first communication link is part of an electronic or digital communications network, such as the global computer network known as the Internet. The present invention contemplates a maximization of the communication options available to individuals who wish to order transportation vehicles (e.g., limousines). For instance, the orders may be placed via desk top or laptop computers, cellular telephones, pagers, airport kiosks, and digital palm-sized communications devices. In the present state of wireless technology, any of those consumer electronic devices may access sites on the World Wide Web and send and receive e-mail via the Internet.

The second communications link may take the form of a dedicated telecommunications pathway, such as a cable link, or may be implemented via a public communications system such as the telephone network or the Internet.

In accordance with another feature of the transportation coordinating system of the present invention, the central computer is further programmed with artificial intelligence software to learn transportation-related preferences of the individuals from repeated transportation orders or requests from the individuals. The central computer has a memory storing the detected or learned preferences and is additionally programmed to generate, based on the stored preferences of the individuals, completed transportation orders from partial transportation orders received from the individuals over the first communication link.

In accordance with a further feature of the present invention, the central computer has a memory storing rules established by the transportation service providers. The central computer is then programmed to select among the preselected ones of the management computers partially pursuant to the stored rules.

The present invention further contemplates the coordination of ground transportation provision at the destination end of an airline flight with the provision of ground transportation at the departure end or terminus of the airline flight. Thus, the central computer is supplementarily programmed to communicate with a management computer of a remote transportation service provider located in a distant metropolitan region remote from the metropolitan region of the multiple transportation service providers. The central computer is programmed to secure a reservation for a transportation vehicle from the management computer of the remote transportation service provider, whereby an individual with an airline flight reservation may automatically obtain ground transportation service at a departure end or beginning terminus and at a destination end of a flight.

In a transportation coordinating method related to the above-described system, a list of transportation service providers is stored for each of a plurality of client organizations, where the client organizations have service contracts with the listed service providers. For each of the transportation service providers, a set of rules is stored pertaining to the provision of services by the respective transportation service provider to the client organizations with which the respective transportation service provider has service contracts. Upon a receipt of orders from respective individual employees of the client organizations for transportation vehicles, computers of particular transportation service providers selected in accordance with the stored lists are automatically or electronically accessed. Upon accessing of the computers, availability of transportation vehicles of the transportation service providers to fulfill the orders in accordance with the stored rules of the transportation service providers is determined.

The method further comprises receiving, from the computers, signals encoding confirmations of vehicle availability, and transmitting, to the individual employees placing transportation orders, digitally encoded confirmations of fulfillment of the respective orders.

A transportation management method comprises, in accordance with another embodiment of the present invention, (a) receiving, from an individual via an electromagnetic signal link, a digitally encoded order for a vehicle for transporting the individual from a particular location, (b) automatically or electronically accessing, in response to the receipt of the order, a computer of a transportation service provider via a communications link to determine availability of a vehicle of the transportation service provider to fulfill the order, (c) receiving, from the computer, a signal encoding a confirmation of vehicle availability, and (d) transmitting, to the individual via the electromagnetic signal link, a digitally encoded confirmation of fulfillment of the order. The automatic or electronic accessing of the computer generally includes automatically or electronically accessing a database of the computer to determine presence of a vehicle of the transportation service provider within a predetermined region about the particular location.

Where the individual is an employee of an organization and the transportation service provider is a one of a plurality of transportation service providers under contract to the organization, the computer being a first computer, the method further comprises (e) automatically or electronically accessing, in response to the receipt of the order and prior to the accessing of the computer of the one of the transportation service providers, a second computer of another one of the transportation service providers via a communications link to determine availability of a vehicle of the another one of the transportation service providers to fulfill the order, and (f) automatically consulting a timer during the automatic or electronic accessing of the second computer. The first computer is accessed upon passage of a predetermined time period after commencement of the automatic or electronic accessing of the second computer, and in the absence of receiving any indication of availability from the second computer.

The present invention contemplates a system and associated method wherein all functions are performed automatically or electronically, that is, without human intervention. The receiving of the orders, the accessing of the computers of the transportation service providers, the receiving of the confirmation signals and the transmitting of the digitally encoded confirmations are all implemented in an absence of operator intervention. It is contemplated that multiple client organizations (clients of the limousine services) and multiple transportation service providers are all served by the method and system of the present invention. Corporate users of transportation services may specify preferred limousine companies for use by the employees and guests of the corporate users. These preferences are stored in memory and followed automatically by the transportation coordinating or management system of the present invention. Similarly, the internal rules of the limousine services are stored in memory and followed automatically by the transportation coordinating system in dealing with the limousine service companies. Of course, the corporate users of the transportation services and the transportation service providers are free to alter their preferred lists and rules of car selection and have the alterations incorporated immediately into the transportation coordinating system.

As alluded to above, a transportation coordinating or managing system in accordance with the present invention may be programmed with artificial intelligence software for learning the transportation preferences of individual users (e.g., corporate employees). Where a plurality of transportation orders are received from an individual user over time, a main computer operates under the artificial intelligence software to determine a preference of the individual with respect to at least one of multiple possible transportation parameters. These personal transportation parameters include the individual's departure and destination end points. Other, optional parameters include the type of car (where there is a choice), travel route, stops along the way, tobacco consumption permissibility, climate settings, and entertainment options such as the availability of a television set or musical selections. Detected preference information is used to predictively generate completed transportation orders from partial orders or requests placed by the individual service users. This method generally facilitates the completion of orders and expedites the entire process. Of course, the individual users are provided with an opportunity to confirm that the automatically completed orders generated by the artificial intelligence are acceptable.

A transportation reservation method comprises, in accordance with an embodiment of the present invention, (i) receiving, via a telecommunications link, a request for transportation identifying a customer and specifying, at least indirectly, a departure location and an airline flight number, (ii) automatically or electronically searching, in response to the request, an on-line database to determine particulars relating to the flight number, (iii) automatically or electronically reserving, upon the determination of the particulars relating to the flight number, a space on a first vehicle for transporting the identified customer from the departure location to a departure airport for an airline flight bearing the flight number, and (iv) automatically or electronically reserving a space on a second vehicle for transporting the identified customer from an arrival airport for the airline flight bearing the flight number.

The telecommunications links in a method in accordance with the present invention preferably include the Internet. However, the communications links may be implemented via a telephone network, a private computer network, or a dedicated connection (cable, wireless connection, satellite).

A transportation coordinating and management system in accordance with the present invention provides maximum flexibility to individual users. The individual users can order and receive confirmation of order fulfillment, using any personal communication device, including cell phones, pagers, personal digital assistants, and hand held and notebook computers, as well as public communications facilities such as specially provided airport kiosks. Moreover, corporate users can control the priority with which the various transportation service providers are contacted by the employees of the corporations. Service providers in turn can have their own internal rules automatically followed in the order fulfillment process.

### BRIEF DESCRIPTION OF THE DRAWINGS

FIG. 1 is a block diagram of a transportation coordinating system in accordance with the present invention.

FIG. 2 is a block diagram showing functional components of the transportation coordinating system of FIG. 1.

FIG. 3 is a block diagram of a central or main transportation coordination server computer of the system of FIGS. 1 and 2, showing selected functional units of the server computer.

FIG. 4 is partially a flow chart and partially an iconographic block diagram showing login and operational routines of a transportation coordinating system in accordance with the present invention.

FIG. 5 is an iconographic block diagram of an expanded transportation coordinating system in accordance with the present invention.

### DESCRIPTION OF THE PREFERRED EMBODIMENTS

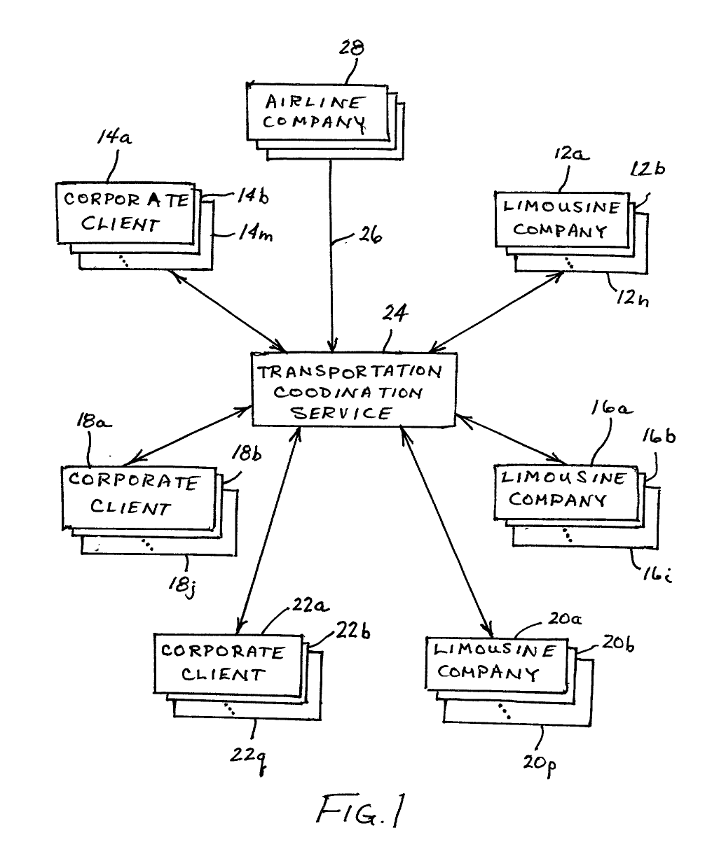

As illustrated in FIG. 1, a transportation system includes a plurality of transportation service providers 12a, 12b, . . . 12n serving multiple client organizations 14a, 14b, . . . 14m in a first metropolitan area, another plurality of transportation service providers 16a, 16b, . . . 16i serving client organizations 18a, 18b, . . . 18j in a second metropolitan area, and yet another plurality of transportation service providers 20a, 20b, . . . 20p serving multiple client organizations 22a, 22b, . . . 22q in a third metropolitan area. A transportation coordinating service 24 is provided for fielding or filling transportation requests or orders placed by individual employees of the client organizations 14a, 14b, . . . 14n, 18a, 18b, . . . 18j, and 22a, 22b, . . . 22q. More particularly, transportation coordinating service 24 receives requests or orders for ground transportation and communicates with transportation service providers 12a, 12b, . . . 12n, 16a, 16b, . . . 16i, and 20a, 20b, . . . 20p in the metropolitan regions in which the individuals placing the transportation orders are located.

Client organizations 14a, 14b, . . . 14m, 18a, 18b, . . . 18j, and 22a, 22b, . . . 22q are typically corporations, while transportation service providers 12a,12b, . . . 12n, 16a, 16b, . . . 16i, and 20a, 20b, . . . 20p typically take the form of limousine companies. Each transportation service provider 12a, 12b, . . . 12n, 16a, 16b, . . . 16i, and 20a, 20b, . . . 20p has a respective fleet 12x, 16x, 20x of limousines. Transportation coordinating service 24 optionally has communications links 26 to computers 28 of airlines for checking reservation and flight information as an adjunct service to coordinating ground transportation requests among employees of corporate client organizations 14a, 14b, . . . 14m, 18a, 18b, . . . 18j, and 22a, 22b, . . . 22q and transportation service providers 12a, 12b, . 12n,16a,16b, . . . 16i, and 20a, 20b, . . . 20p.

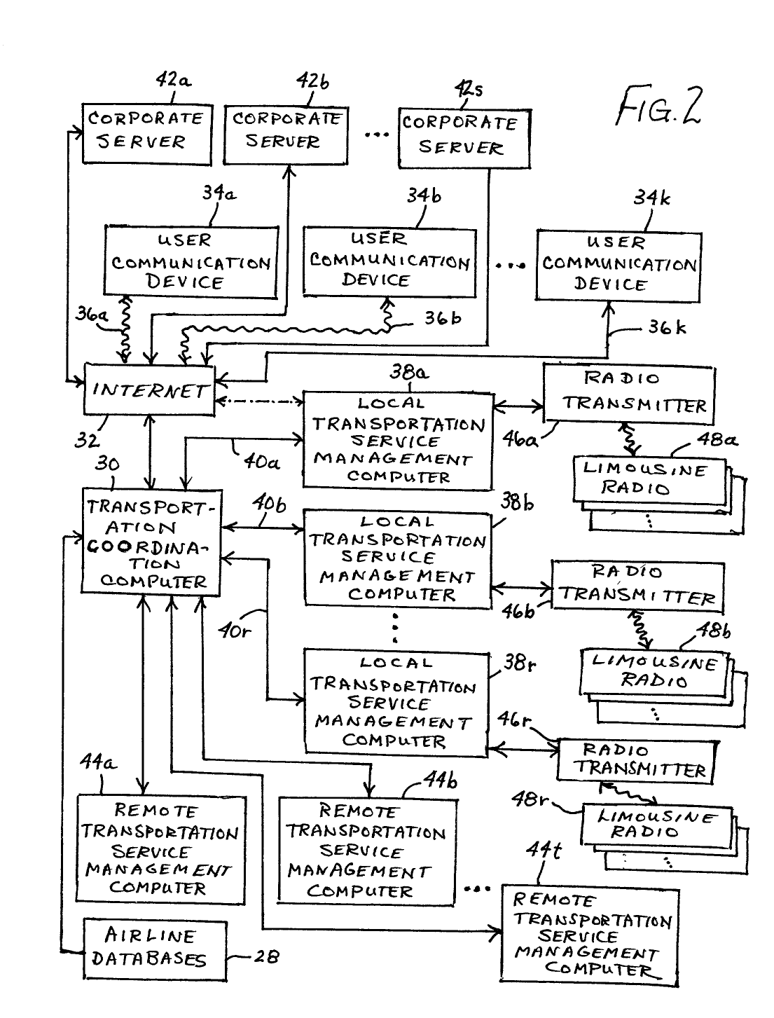

As illustrated in FIG. 2, transportation coordinating service 24 includes at least one central server computer 30 which is connected to the global computer network known as the Internet 32 for receiving transportation orders or requests placed by individual users via respective communication devices 34a, 34b, . . . 34k. Communication devices may be connected to the Internet 32 via wired or wireless communications links 36a, 36b, . . . 36k. Communications devices 34a, 34b, . . . 34k may take any suitable form such as cell phones, pagers, personal digital assistants, and hand held and notebook computers, as well as public communications facilities such as specially provided airport kiosks.

For purposes of simplicity, FIG. 2 depicts only that portion of the system of FIG. 1 serving a single metropolitan area. Of course, the description is identical as to other metropolitan areas. As shown in FIG. 2, transportation coordinating server computer 30 may communicate via the Internet 32 with management computers 38a, 38b, . . . 38r of respective transportation service providers 12a, 12b, . . . 12n, or 16a, 16b, . . . 16i, or 20a, 20b, . . . 20p. Alternatively or additionally, communication between server computer 30 and management computers 38a, 38b, . . . 38r may be accomplished over dedicated communications pathways 40a, 40b, . . . 40r such as optical cables or wireless links possibly via satellites (not shown).

As further illustrated in FIG. 2, transportation coordinating server computer 30 may communicate over the Internet 32 with corporate computers 42a, 42b, . . . 42s of client organizations 14a, 14b, . . . 14m, or 18a, 18b, . . . 18j, or 22a, 22b, . . . 22q. This communication enables server computer 30 to collect information from each client organization 14a, 14b, . . . 14m, 18a, 18b,. . . 18j, and 22a, 22b, . . . 22q such as preferred transportation service providers 12a, 12b, . . . 12n, 16a,16b, . . . 16i, and 20a, 20a, . . . 20p, including the preferred order of priority among those preferred providers. In addition, server computer 30 is enabled to confirm identification of individual users for purposes of checking proper authorization to use the transportation service providers 12a, 12b, . . . 12n, 16a, 16b, . . . 16i, and 20a, 20b, . . . 20p listed for the respective client organizations 14a, 14b, . . . 14m, 18a, 18b, . . . 18j, and 22a, 22b, . . . 22q. Different individual users may be authorized to use different transportation service providers 12a, 12b, . . . 12n, 16a,16b, . . . 16i, and 20a, 20b, . . . 20p.

As discussed in detail hereinafter, server computer 30 may be instrumental in reserving ground transportation via a remote transportation service provider computer 44a, 44b, . . . , 44t, as well as ordering an immediate ride from a local transportation service provider computer or management computer 38a, 38b, . . . 38r, where a local user indicates that he or she has booked an airline flight. The user advises server computer 30 as to the airline and flight number of the user's imminent flight. Server computer 30 contacts the appropriate airline computer 28 via the Internet 32 to confirm expected arrival time and destination.

As additionally illustrated in FIG. 2, each management computer 38a, 38b, . . . 38r is operatively connected to a respective radio transceiver 46a, 46b, . . . 46r for wirelessly communicating with respective fleets of limousine automobiles 48a, 48b, . . . 48r. More particularly, management computers 38a, 38b, . . . 38r are connected via transceivers 46a, 46b, . . . 46r to availability switches or other communication devices (not shown) in the limousines 48a, 48b, . . . 48r.

Individual employees of corporate client organizations 14a, 14b,. . . 14m, 18a, 18b, . . . 18j, and 22a, 22b, . . . 22q contact server computer 30 by logging onto a World Wide Web site generated by server computer 30. Upon providing identification information, the user interacts with the Web site to place an order for a vehicle. Certain minimum information is required for server computer to process the order, including the present location of the passenger (the pickup location) and, preferably, the destination location. Server computer 30 is programmed to automatically access preselected ones of the management computers 38a, 38b. . . 38r in response to orders or requests received from user communication devices 34a, 34b, . . . 34k over communication links 36a, 36b, . . . 36k. The accessed management computers 38a, 38b, . . . 38r are selected pursuant to the preferences of corporate client organizations 14a,14b, . . . 14m, 18a, 18b, . . . 18j, and 22a, 22b, . . . 22q, as communicated to server computer 30 via corporate computers 42a, . . . 42b, . . . 42s.

In accessing management computers 38a, 38b, . . . 38r, server computer 30 has searches undertaken of the databases or memories of the accessed management computers 38a, 38b, . . . 38r for available transportation vehicles or limousines 48a, 48b, . . . 48t of respective preselected transportation service providers 12a, 12b, . . . 12n, 16a, 16b,. . . 16i, and 20a, 20b, . . . 20p. Management computers 38a, 38b,. . . 38r may be provided with software for enabling the direct access to their respecive databases by server computer 30. Server computer 30 undertakes its searches of those databases and obtains vehicle availability confirmations through the respective management computers 38a, 38b, . . . 38r and transceivers 46a, 46b, . . . 46r pursuant to the internal rules of the respective transportation service providers 12a, 12b, . . . 12n, 16a, 16b, . . . 16i, and 20a, 20b, . . . 20p. For instance, upon discovering several cars 48a, 48b, . . . 48r of a selected transportation service provider 12a, 12b, . . . 12n, 16a, 16b, . . . 16i, and 20a, 20b, . . . 20p in a region containing the pickup location, server computer 30 contacts a first car of the selected transportation service provider or limousine company pursuant to the relevant rule of that company. Usually, the relevant rule requires selection of the first car to arrive (indicate availability) in the region containing the pickup location. Then, server computer 30, perhaps through the respective management computer 38a, 38b, . . . 38r, contacts the first car and waits for confirmation. The wait before contacting a second car of the selected transportation service provider or limousine company 12a, 12b, . . . 12n, 16a, 16b, . . . 16i, or 20a, 20b, . . . 20p is again determined by the internal rule of that limousine company.

Server computer 30 is programmed to obtain confirmations received from contacted limousines 48a, 48b, . . . 48r of selected transportation service provider 12a, 12b, . . . 12n, 16a, 16b, . . . 16i, and 20a, 20b, . . . 20p. The confirmations indicate that the contacted limousines 48a, 48b, . . . 48r are able to pick up the individual passengers from their respective pick up locations within predetermined time intervals after placement of the transportation orders or requests. Server computer 30 is also programmed to communicate the confirmations to the communication devices 34a, 34b, . . . 34k of individual corporate employees over the respective communication links 36a, 36b, . . . 36k.

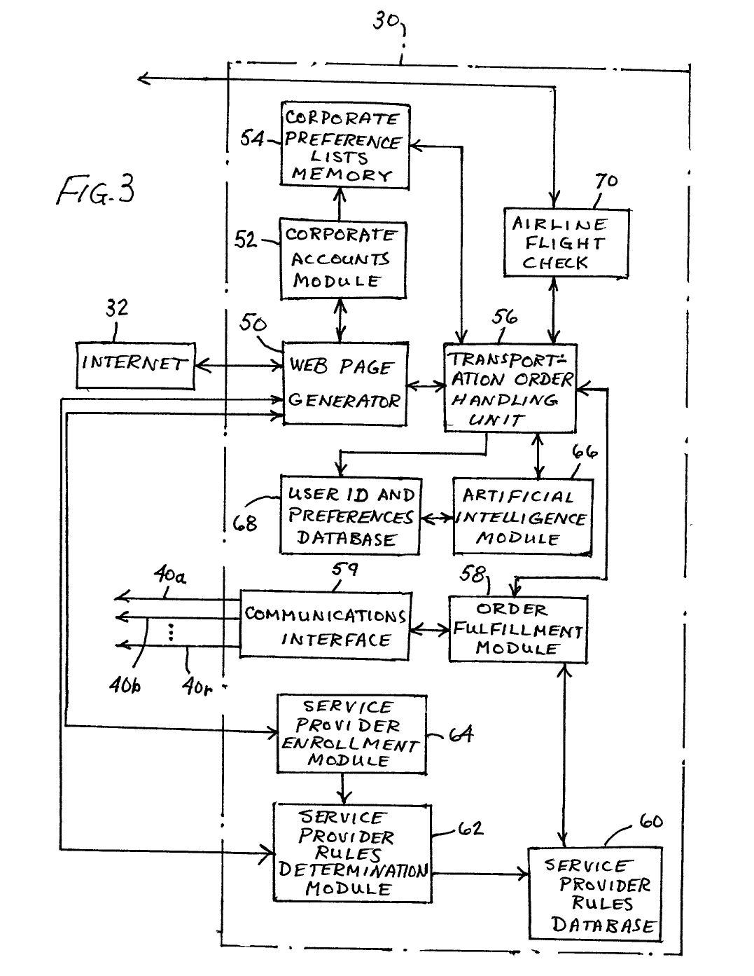

As illustrated in FIG. 3, server computer 30 includes a Web page generator 50 which is connected to the Internet 32 for providing Web sites by which the server computer communicates with user communication devices 34a, 34b, . . . 34k, corporate server computers 42a, 42b, . . . 42s, and possibly management computers 38a, 38b, . . . 38r during an enrollment process by which transportation service provider 12a, 12b, . . . 12n, 16a, 16b, . . . 16i, and 20a, 20b, . . . 20p become subscribers to the system. After this enrollment process, server computer 30 preferably communicates with management computers 38a, 38b, . . . 38r via dedicated pathways 40a,40b, . . . 40r.

It is contemplated that, upon the receipt of order information or other communication from a user, Web page generator 50 merely refreshes a basic Web page to indicate the receipt of the information. Thus, communication with a user is implemented by updating data entry fields in a standard Web page, depending on the data from the user. In an alternative procedure, Web page generator 50 produces a stream of new Web pages depending on the input from the user.

Server computer 30 includes a corporate account module 52 which interacts with Web site generator 50 for purposes of obtaining information from client organizations 14a,14b, . . . 14m, 18a, 18b, . . . 18j, and 22a, 22b, . . . 22q via respective corporate computers 42a, 42b, . . . 42s. This information includes the identities of the transportation service providers 12a, 12b, . . . 12n,16a, 16b, . . . 16i, and 20a, 20b, . . . 20p with which the client organizations 14a, 14b, . . . 14m, 18a, 18b, . . . 18j, and 22a, 22b, . . . 22q have service contracts and further includes rankings of the service providers or limousine companies in order of preferred use. Other information obtained from corporate computers 42a, . . . 42b, . . . 42s by module 52 includes the identities of corporate personnel who are authorized to request limousines and possibly identifies different transportation service providers 12a, 12b, . . . 12n, 16a, 16b, . . . 16i, and 20a, 20b, . . . 20p which different personnel are authorized to use. All the information obtained by corporate account module 52 is stored in a respective memory 54 of server computer 30.

Server computer 30 also includes a transportation order handling unit 56 which interacts with Web site generator 50 to receive transportation requests or orders from individual users. The receiving of transportation requests or orders includes logging individual users into the system and ensuring that the users are authorized to make transportation requests. To that end, unit 56 is connected to memory 54.

Upon detecting a proper login by an authorized user, transportation order handling unit 56 activates an order fulfillment module 58 which is connected to management computers 38a, 38b, . . . 38r via a communications interface 59 and dedicated communications pathways 40a, 40b, . . . 40r for cooperating with the management computers to canvas available drivers and obtain confirmations of pickup intent on the parrts of the drivers of limousines 48a, 48b, . . . 48r. As discussed above, the selection of limousines 48a, 48b, . . . 48r for possible engagement, the contacting of those limousines, the waiting for confirmations therefrom, etc., all proceed according to the rules set by the individual transportation service providers 12a, 12b, . . . 12n, 16a, 16b, . . . 16i, and 20a, 20b, . . . 20p. To that end, order fulfillment module 58 is operatively connected to a service provider rules database 60. Rules of the respective transportation service providers 12a, 12b, . . . 12n,16a,16b, . . . 16i, and 20a, 20b, . . . 20p are stored in database 60 by a rule collection or determination module 62 which works, for instance, with Web site generator 50 to extract the rules from transportation service providers 12a, 12b, . . . 12n, 16a, 16b, . . . 16i, and 20a, 20b, . . . 20p via management computers 38a, 38b, . . . 38r. Alternatively, the rules of the various transportation service providers 12a, . . . 12b, . . . 12n, 16a, 16b, . . . 16i, and 20a, 20b, . . . 20p may be modified and communicated to server computer 30 via various communications vehicles.

Server computer 30 further includes a service provider enrollment module 64 which interacts with Web page generator 50 to enroll transportation service providers 12a, 12b, . . . 12n, 16a, 16b, . . . 16i, and 20a, 20b, . . . 20p in the transportation coordinating system 24 (FIG. 2). Enrollment entails in part the acquisition by server computer 30 of necessary communication identification information and the transmission to the management computers 38a, 38b, . . . 38r of software for enabling the interaction of server order handling unit 56 and to a user identification and preference database 68 of server computer 30. Database 68 stores individual order data received from order handling unit 56. That data is analyzed by artificial intelligence module 66 to determine users' preferences as to predetermined transportation parameters such as departure and destination addresses. Other, optional parameters include the type of car (where there is a choice), travel route, stops along the way, tobacco consumption permissibility, HVAC settings, and entertainment options such as the availability of a television set or musical selections.

When transportation order handing unit 56 receives a partial request for transportation services from a known user, artificial intelligence module 66 may tap into memory 68 to determine the likely particulars of parameters missing from the partial transportation request. This missing information is furnished back to the user, after an inquiry to verify proper authorization of the user, by order handling module 56 and Web page generator 50, for purposes of obtaining a confirmation from the user. Thus, artificial intelligence module 66 uses detected preference information to predictively generate completed transportation orders from partial orders or requests placed by the individual users. Database or memory 68 may store the detected or learned preferences.

Server computer 30 also functions to coordinate ground transportation at the destination end of an airline flight with the provision of ground transportation at the departure end of the airline flight. To that end, server computer 30 is provided with an airline flight checking unit 70 cooperating with order handling unit 56 and order fulfillment module 58 to extract flight information (e.g., airline and flight number) from a user via a respective user communication device 34a, 34b, . . . 34k and the Internet 32. Airline flight checking unit 70 is connected to airline flight data computers 28 via communications links 26 to confirm such relevant flight particulars as destination airport and estimated arrival time. Order fulfillment module 58 cooperating with airline flight checking module 70 and communicates with management computers 44a, 44b, . . . 44t of respective remote transportation service providers located in a distant metropolitan region remote from the metropolitan region served by management computers 38a, 38b, . . . 38r. Via order fulfillment module 58, server computer 30 secures a reservation for a transportation vehicle from the management computer 44a, 44b, . . . 44t of a remote transportation service provider, whereby an individual with an airline flight reservation may automatically obtain ground transportation service at a destination end of a flight.

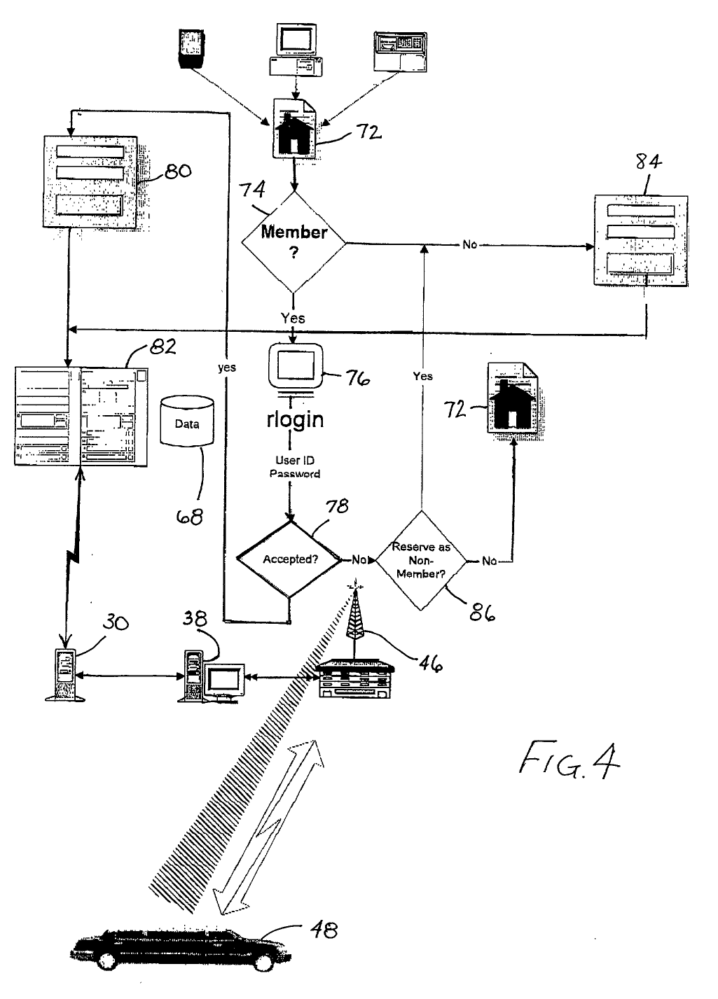

FIG. 4 is a flow chart illustrating in part login procedures not only for a transportation requester who is an employee or authorized user of a client organization 14a, 14b, . . . 14m, 18a, 18b, . . . 18j, and 22a, 22b, . . . 22q, but also for an unaffiliated individual. Communications devices 34a, 34b, . . . 34k in the form of a personal digital assistant, an office PC and an airport kiosk, respectively, transmit transportation orders or requests by communicating via voice, handwritten input or keyboard/keypad input with a home page 72 produced by Web page generator 50 (FIG. 3). Server computer 30 and particularly order handling unit 56 in cooperation with Web page generator 50 then inquires at 74 whether the requesting individual is an authorized user or an unaffiliated person. Where the requester is an authorized user of a member or client organization 14a, 14b, . . . 14m, 18a, 18b, . . . 18j, and 22a, 22b, . . . 22q, login proceeds according to routines 76 executed by order handling unit 56. Login includes the reception of proper user ID and password. If the entered ID and password are valid, as determined by order handling unit 56 of server computer 30 at a decision junction 78, the logged-in requester is presented by the order handling unit and Web page generator 50 with a member reservation or order form in a step 80. After login and the submission of the user's password and/or personal identification number, the reservation or order form automatically displays the user's name, and the respective member or client organization 14a, 14b, . . . 14m, 18a, 18b, . . . 18j, and 22a, 22b, . . . 22q. The reservation form solicits additional information from the user, including pickup location and destination location. Where an airline flight is being caught by the user, additional information is solicited in a pop-up window and includes the airline, flight number, departure airport, time of departure, arrival airport and arrival time. Step 80 may include a reorganization and display of the collected data back to the user. The user may be asked for a confirmation of the user's order. Subsequently, the user receives at least one confirmation, two in the case that an airline flight is involved.

Order handling unit 56 and artificial intelligence module or middleware 66 analyze the incoming reservation data in a step 82 to generated a completed order. Upon the completion of the order entry, a management or server computer 38 (38a, 38b, . . . 38r) of a transportation service provider 12a, 12b, . . . 12n, 16a, 16b, . . . 16i, and 20a, 20b, . . . 20p is contacted as described above. A generically designated limousine 48 is then contacted via a generic wireless transmitter 46, as described above.

If the requester is not an authorized user of a member or client organization 14a, 14b, . . . 14m, 18a, 18b, . . . 18j, and 22a, 22b, . . . 22q, as determined by order handling unit 56 of server computer 30 at inquiry 74, a non-member reservation form is presented to the requester by handling unit 56 via Web page generator 50 in a step 84. The reservation or order form 84 solicits information from the non-member user including the user's name, the name and address of the user's company or organization, if any, address of the user, pickup location, destination location, number of stops along the way, and credit card information. Where an airline flight is being caught by the non-member user, additional information includes the airline, flight number, departure airport, time of departure, arrival airport and arrival time. Step 84 may include a reorganization and display of the collected data back to the user. The user may be asked for a confirmation of the user's order. Subsequently, the user receives at least one confirmation, two in the case that an airline flight is involved.

A valid filling out of the reservation form in step 84 leads to the processing of the order beginning with step 82. It is to be understood that reservation information may be obtained via methods other than the presentation of Web page forms. For instance, a series of inquiries may be transmitted to the requester, which the requester answers in seriatim.

Where an apparently authorized employee of a member of a member or client organization 14a, 14b, . . . 14m, 18a, 18b, . . . 18j, and 22a, 22b, . . . 22q fails to enter correct ID and password data, as detected by order handling unit 56 at decision junction 78, the requester is asked at 86 whether he or she wishes to order a limousine as a nonmember individual. If so, reservation form is presented in step 84. If not, the requester is returned to the home page 72.

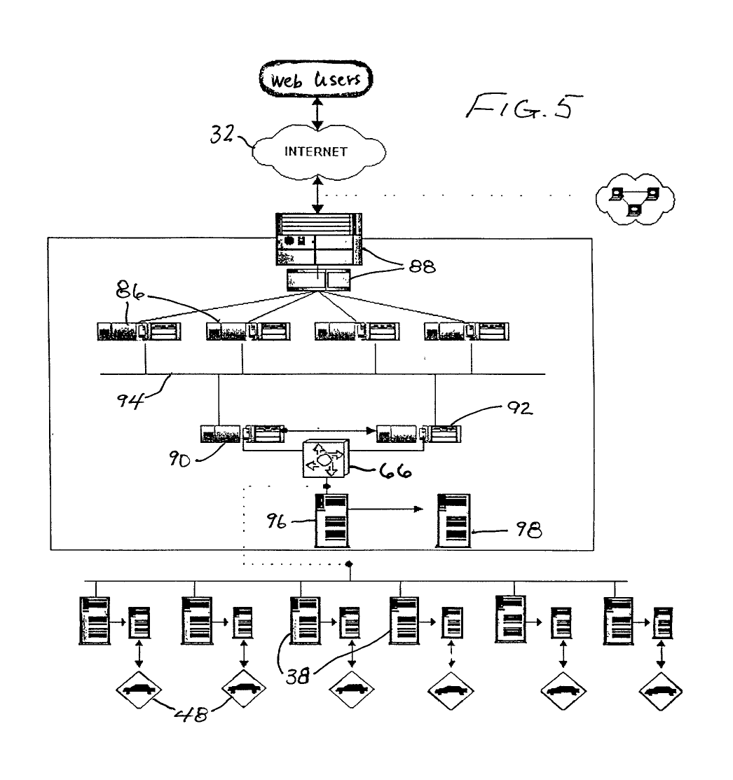

The icon type block diagram of FIG. 5 indicates that the transportation coordination system 24 (FIG. 1) described herein may be provided with redundant componentry for ensuring successful handling of transportation order requests, regardless of load and regardless of power outages or other equipment failure. Specifically, a plurality of Web servers 86 may be provided in parallel for handling incoming transportation requests from users via communication devices 34a, 34b, . . . 34k (FIG. 2). A router (e.g., Cisco Gigabit Switch Router) and load balancer 88 are connected at a back end to Web servers 86, for instance, via an optical fiber network, for distributing and equalizing work loads of the various Web servers 86. Web servers 86 are provided with encryption capability and are preferably guarded by firewall software configured for reliability.

Redundant applications servers 90 and 92 are connected to Web servers 86 via a multicast network 94 for cooperating with the Web servers to process transportation requests and orders. Applications servers 90 and 92 are provided with artificial intelligence software 66 (e.g., Haley's middleware) for managing requests arriving via the Web site of the transportation coordination service, writing transaction information to the collective database (memory 54, databases 60 and 64, FIG. 3), as well as to the memories of the management computers 38a, 38b, . . . 38r, and 44a, 44b, . . . 44t, and automatically matching requests to available limousines. Duplicate central databases 96 and 98 may also be provided. It is clear, therefore, that the various functional components of server computer 30 illustrated in FIG. 3 may be located in different computers: the work of Web page generator 50 and associated Internet related functions may be performed by specialized Web servers 86, while order processing and artificial intelligence operations are performed by redundantly provided applications severs 90 and 92. Memory 54 and databases 60 and 68 are duplicated at 96 and 98 in parallel with redundant applications servers 90 and 92.

Although the invention has been described in terms of particular embodiments and applications, one of ordinary skill in the art, in light of this teaching, can generate additional embodiments and modifications without departing from the spirit of or exceeding the scope of the claimed invention. Accordingly, it is to be understood that the drawings and descriptions herein are proffered by way of example to facilitate comprehension of the invention and should not be construed to limit the scope thereof.

What is claimed is:

1. Interfacing with a transportation system having a plurality of transportation service providers serving a plurality of client organizations in a given area, a transportation coordinating system comprising:
first communication means for enabling the transmission of transportation orders or requests from individuals of the various client organizations;
at least one central computer operatively connected to said first communication means for receiving transportation orders or requests from said individuals; and
second communication means for operatively linking said central computer to management computers of the transportation service providers,
said central computer being programmed to automatically access preselected ones of said management computers in response to orders or requests received from said individuals over said first communication means,
said central computer being further programmed to have searches undertaken of databases or memories of said preselected ones of said management computers for available transportation vehicles of respective preselected transportation service providers,
said central computer being additionally programmed to obtain confirmations of available transportation vehicles able to pick up said individuals from respective pick up locations within predetermined time intervals after placement of said orders or requests by said individuals,
said central computer also being programmed to communicate said confirmations to said individuals over said first communication means.

2. The transportation coordinating system of claim 1 wherein said central computer is further programmed with artificial intelligence software to learn transportation-related preferences of said individuals from repeated transportation orders or requests from said individuals, said central computer having a memory storing said preferences, said computer being additionally programmed to generate, based on the stored preferences of said individuals, completed transportation orders from partial transportation orders received from said individuals over said first communication means.

3. The transportation coordinating system of claim 1 wherein said central computer has a memory storing rules established by said transportation service providers, said central computer being further programmed to select among said preselected ones of said management computers partially pursuant to the stored rules.

4. The transportation coordinating system of claim 1 wherein at least one of said first communication means and said second communication means includes a global computer network.

5. The transportation coordinating system of claim 1 wherein said transportation service providers are all located within a single metropolitan region, said central computer being supplementarily programmed to communicate with a management computer of a remote transportation service provider located in a distant metropolitan region remote from said single metropolitan region, said central computer being further programmed to secure a reservation for a transportation vehicle from the management computer of said remote transportation service provider, whereby an individual with an airline flight reservation may automatically obtain ground transportation service at a departure end and at a destination end of a flight.

6. A transportation coordinating method comprising:
over time, receiving multiple orders from each of a plurality of individuals for transportation vehicles, each of said orders specifying particulars of multiple transportation parameters;
using artificial intelligence software to detect, from said multiple orders, preferences of said individuals with respect to at least some of said multiple transportation parameters;
storing said preferences;
after the storing of said preferences, receiving requests from said individuals for transportation vehicles, said requests providing particulars with respect to only a limited number of said transportation parameters; and
automatically completing transportation orders from said requests pursuant to the store d preferences.

7. The method defined in claim 6, further comprising:
automatically accessing computers of a plurality of transportation service providers in response to the received orders, in order to determine availability of transportation vehicles; and
automatically providing confirmation of vehicle availability to the individuals placing the received orders.

8. The method defined in claim 7 wherein the individuals are employees of respective client organizations each having a service contract with at least one of said transportation service providers, the accessing of said computers being in accordance with the service contracts so that vehicles are provided to individuals only by those transportation service providers having contracts with the respective individuals' organizations.

9. The method defined in claim 7 wherein the providing of confirmation of vehicle availability includes checking availability in accordance with rules furnished by said transportation service providers.

10. The method defined in claim 7 wherein said transportation service providers are all located within a single metropolitan region, further comprising:
communicating with a computer of a remote transportation service provider located in a distant metropolitan region remote from said single metropolitan region;
automatically securing a reservation for a transportation vehicle from the computer of said remote transportation service provider, whereby an individual with an airline flight reservation may automatically obtain ground transportation service at a departure end and at a destination end of a flight.

11. The method defined in claim 6, further comprising transmitting the completed transportation orders to said individuals in response to said requests and requesting confirmation of said completed transportation orders.

12. The method defined in claim 6 wherein the receiving of the multiple orders, the using of artificial intelligence software, the storing of the preferences, the receiving of the requests, and the completing of the transportation orders are all performed in the absence of operator intervention.

13. The method defined in claim 6 wherein said orders are received over a computer network.

14. In a transportation system having a plurality of transportation service providers serving a plurality of client organizations in a given area, a transportation coordinating method comprising:
storing, for each of said client organizations, a list of said transportation service providers with which the respective client organization has service contracts;
also storing, for each of said transportation service providers, a set of rules pertaining to the provision of services by the respective transportation service provider to the client organizations with which the respective transportation service provider has service contracts;
receiving a plurality of orders from respective individual employees of the client organizations for transportation vehicles;
in response to the receipt of said orders, automatically or electronically accessing computers of particular transportation service providers selected in accordance with the stored lists; and
upon accessing of said computers, determining availability of transportation vehicles of said transportation service providers to fulfill said orders in accordance with the stored rules of the transportation service providers.

15. The method defined in claim 14, further comprising:
receiving, from said computers, signals encoding confirmations of vehicle availability; and
transmitting, to the individual employees placing transportation orders, digitally encoded confirmations of fulfillment of the respective orders.

16. The method defined in claim 14, further comprising:
over time, receiving multiple orders from each of the individual employees for transportation vehicles, each of said orders specifying particulars of multiple transportation parameters;
using artificial intelligence software to detect, from said multiple orders, preferences of said individual employees with respect to at least some of said multiple transportation parameters;
storing said preferences;
after the storing of said preferences, receiving requests from said individual employees for transportation vehicles, said requests providing particulars with respect to only a limited number of said transportation parameters; and
automatically completing transportation orders from said requests pursuant to the stored preferences.

17. The method defined in claim 14 wherein said transportation service providers are all located within a single metropolitan region, further comprising:
communicating with a computer of a remote transportation service provider located in a distant metropolitan region remote from said single metropolitan region; and
automatically securing a reservation for a transportation vehicle from the computer of said remote transportation service provider, whereby an individual with an an airline flight reservation may automatically obtain ground transportation service at a departure end and at a destination end of a flight.

18. The method defined in claim 14 wherein the storing of the lists of said transportation service providers, the storing of the rules, the receiving of transportation orders, the automatic or electronic accessing of computers of particular transportation service providers, and the determining transportation vehicle availability are all performed in the absence of operator intervention.

19. The method defined in claim 14 wherein said orders are received from the individual employees over a computer network.

20. A transportation management method comprising:
receiving, from an individual via an electromagnetic signal link, a digitally encoded order for a vehicle for transporting the individual from a particular location;
in response to the receipt of said order, automatically or electronically accessing a computer of a transportation service provider via a communications link to determine availability of a vehicle of said transportation service provider to fulfill said order;
receiving, from said computer, a signal encoding a confirmation of vehicle availability; and
transmitting, to said individual via said electromagnetic signal link, a digitally encoded confirmation of fulfillment of said order.

21. The method defined in claim 20 wherein the automatic or electronic accessing of said computer includes automatically or electronically accessing a database of said computer to determine presence of a vehicle of said transportation service provider within a predetermined region about said particular location.

22. The method defined in claim 20 wherein said individual is an employee of an organization, said transportation service provider being a one of a plurality of transportation service providers under contract to said organization, said computer being a first computer, further comprising:
in response to the receipt of said order and prior to the accessing of said computer of said one of said transportation service providers, automatically or electronically accessing a second computer of another one of said transportation service providers via a communications link to determine availability of a vehicle of said another one of said transportation service providers to fulfill said order;
automatically consulting a timer during the automatic or electronic accessing of said second computer;
upon passage of a predetermined time period after commencement of the automatic or electronic accessing of said second computer, and in the absence of receiving, from said second computer, a signal encoding a confirmation of vehicle availability, automatically or electronically accessing said first computer to determine availability of a vehicle of said one of said transportation service providers to fulfill said order.

23. The method defined in claim 20, further comprising operating a World Wide Web site, wherein the receiving of said order and the transmitting of said digitally encoded confirmation are carried out via said Web site.

24. The method defined in claim 20 wherein the receiving of said order, the accessing of said computer, the receiving of said signal and the transmitting of said digitally encoded confirmation are all implemented via a global computer network.

25. The method defined in claim 20 wherein the receiving of said order, the accessing of said computer, the receiving of said signal and the transmitting of said digitally encoded confirmation are all implemented in an absence of operator intervention.

26. The method defined in claim 20, further comprising:
receiving a plurality of transportation orders from said individual over time, said transportation orders specifying particulars of multiple transportation parameters; and
operating a computer under artificial intelligence software to determine a preference of said individual with respect to at least one of said parameters.

27. The method defined in claim 20 wherein said digitally encoded order is an encoded voice message, further comprising operating voice-recognition software to generate said digitally encoded order from voice-frequency pressure waves.

28. In a transportation system having a plurality of transportation service providers serving a plurality of client organizations in a given area, a transportation coordinating method comprising:
receiving an electromagnetic signal encoding an order from an individual employee of one of the client organizations for a transportation vehicle to convey the individual from a particular location;
in response to the receipt of said order, automatically or electronically accessing a computer of a limousine company via a communications link to determine availability of a car of said company to fulfill said order;
receiving, from said computer, a signal encoding a confirmation of car availability; and
transmitting, to said individual via said electromagnetic signal link, a digitally encoded confirmation of fulfillment of said order.

29. The method defined in claim 28 wherein the receiving of said electromagnetic signal, the accessing of said computer, the receiving of the confirmation-encoding signal and the transmitting of said digitally encoded confirmation are all performed in the absence of operator intervention.

30. A transportation reservation method comprising:
receiving, via a telecommunications link, a request for transportation identifying a customer and specifying, at least indirectly, a departure location and an airline flight number;
in response to said request, automatically or electronically searching an on-line database to determine particulars relating to said flight number;
upon the determination of the particulars relating to said flight number, automatically or electronically reserving a space on a first vehicle for transporting the identified customer from said departure location to a departure airport for an airline flight bearing said flight number; and
also upon the determination of the particulars relating to said flight number, automatically or electronically reserving a space on a second vehicle for transporting the identified customer from an arrival airport for said airline flight bearing said flight number.

31. The method defined in claim 30 wherein said telecommunications link is taken from the group consisting of a telephone connection, a global computer network, a private computer network, and an electromagnetic wireless connection.

32. The method defined in claim 30 wherein said telecommunications link includes a global computer network, further comprising automatically or electronically providing a confirmation to the customer after the reserving of space on said first vehicle and said second vehicle.

33. A transportation system wherein a plurality of transportation service providers serve a plurality of client organizations in a given area, the system comprising:
a memory storing, for each of the client organizations, a list of the transportation service providers with which the respective client organization has service contracts and also storing, for each of the transportation service providers, a set of rules pertaining to the provision of services by the respective transportation service provider to the client organizations with which the respective transportation service provider has service contracts;
signal reception means for receiving a plurality of orders from respective individual employees of the client organizations for transportation vehicles;
a main computer operatively connected to said memory and to said signal reception means, said main computer being programmed to automatically or electronically access, in response to the receipt of the orders, management computers of particular transportation service providers selected in accordance with the stored lists,
said main computer being operatively connected to said management computers via a communications link, said main computer being additionally programmed to cooperate with said management computers to determine availability of transportation vehicles of the transportation service providers to fulfill the orders in accordance with the stored rules of the transportation service providers.

34. The system defined in claim 33 wherein said main computer is also programmed to transmit, to the individual employees placing transportation orders, digitally encoded confirmations of fulfillment of the respective orders.

35. The system defined in claim 33 wherein said main computer is programmed with artificial intelligence software to detect, from multiple orders received from the individual employees over time, preferences of the individual employees with respect to at least some of multiple transportation parameters specified in the multiple orders,
said main computer being further programmed to:
store the detected preferences; and
automatically generate, pursuant to the stored preferences, completed transportation orders from partial transportation orders received from the individual employees for transportation vehicles.

36. The system defined in claim 33 wherein the transportation service providers are all located within a single metropolitan region, said main computer being further programmed to:
communicate with a computer of a remote transportation service provider located in a distant metropolitan region remote from the single metropolitan region; and
automatically secure a reservation for a transportation vehicle from the computer of the remote transportation service provider, whereby an individual with an an airline flight reservation may automatically obtain ground transportation service at a departure end and at a destination end of a flight.

37. A transportation coordination system comprising:
an electromagnetic communications link for receiving from an individual a digitally encoded order for a vehicle for transporting the individual from a particular location;
a main computer operatively connected to said communications link, said main computer being programmed to automatically or electronically access, in response to the receipt of said order, a management computer of a transportation service provider to determine availability of a vehicle of said transportation service provider to fulfill said order, said main computer being different from said management computer,
said main computer being also programmed to transmit, to said individual via said electromagnetic communications link, a digitally encoded confirmation of fulfillment of said order upon receiving, from said management computer, a signal encoding a confirmation of vehicle availability.

38. The system defined in claim 37 wherein said main computer is programmed to operate a World Wide Web site, whereby said order is received and said digitally encoded confirmation is transmitted.
